(19) United States
(12) Patent Application Publication
(10) Pub. No.: US 2006/0182253 A1
(43) Pub. Date: Aug. 17, 2006

(54) Unifying business process object modeling

(76) Inventors: Thomas P. Capotosto, Austin, TX (US); David R. Ornelas, Austin, TX (US)

Correspondence Address: HAMILTON & TERRILE, LLP, P.O. BOX 203518, AUSTIN, TX, 78720, US

(21) Appl. No.: 11/056,722

(22) Filed: Feb. 11, 2005

(51) Int. Cl. H04M 3/42

(52) U.S. Cl. 379/212.01

(57) ABSTRACT

A unifying process object modeling is disclosed. The unifying process of object modeling creates a fully traceable service construct that progressively cascades or decomposes from high level business need into standardized business processes, that in turn comprise standardized functions, that in turn comprise standardized tasks and data elements, that in turn link to building block objects, that are implemented either as manual or automated procedures.

### BACKGROUND OF THE INVENTION

1. Field of the Invention

The present invention relates to business process object modeling and more particularly to unifying business process object modeling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity. The entity that services and supports such an installation is often referred to as a managed service provider. Managed services, or life-cycle services generally include deployment services and asset services. More specifically, managed services include some or all of asset deployment and installation services, asset management services (including, e.g., both asset tracking and asset moving services), asset maintenance services and asset retirement services.

A managed service provider provides a customer with an ability to procure, deploy, support and manage information handling system technologies across the life cycle of the information handling systems. Issues relating to managed services include information management and asset utilization while providing quality service delivery and a favorable customer experience.

Known business processes used by a managed service provider are usually defined either from scratch or are based on modifications of existing like processes. The design of business processes is usually not based upon reuse of standard elements drawn from a library or catalog of pre-defined process elements.

The underlying technology systems that are used in business processes are often vertically aligned with the overall process or solution required by the business, producing rigid, monolithic systems. This is opposed to building components that can serve as interchangeable building blocks that correspond directly to process objects that can then be mixed and matched exactly as the business process objects are mixed and matched.

Continually creating new processes from scratch, as opposed to reusing standard pre-defined process elements or building blocks, results in a proliferation of similar but different processes that are sometimes conflicting, sometimes duplicative, resulting in process inefficiencies, inability to achieve process integration, inability to achieve consolidated reporting and management, inability to reuse intellectual capital, and creation of technology requirements that are both conflicting and duplicative. This in turn compromises the ability to create reusable technology building blocks, thereby cascading the same set of problems into the technology infrastructure (i.e., inefficiencies; integration; consolidation, reuse of technology, intellectual capital, and scarce resources; quality, scalability; extensibility; and manageability and supportability).

For example, referring to FIG. 1, labeled prior art, lifecycle components of a managed service process establish a baseline of existing assets at step 110. Lifecycle services add new assets, acquire new assets, order a product and install new assets or order a service at step 112. Lifecycle components request lifecycle changes to existing assets by moving or upgrading existing assets, order a service and maintaining existing assets, or report a problem at step 114. Lifecycle service components retire and replace existing assets by disposing of old assets, order a service and install new assets, or order a service at step 116.

### SUMMARY OF THE INVENTION

In accordance with the present invention, a unifying process object modeling is disclosed. More specifically, the unifying process of object modeling creates a fully traceable service construct that progressively cascades or decomposes from high level business need into standardized business processes, that in turn comprise standardized functions, that in turn comprise standardized tasks and data elements, that in turn link to building block objects, that are implemented either as manual or automated procedures.

The unifying process also creates a store or library of reusable building blocks that can be flexibly assembled to produce build-to-order services and processes.

Accordingly, the invention produces a standardized, irreducible set of building blocks that can be flexibly reused, and that create and enforce traceable linkages among business needs and objectives, operational processes, and technology solutions.

In one embodiment, business solutions are defined and implemented via processes that are based upon an irreducible set of pre-defined building blocks. These building blocks are maintained in a shared library. Additionally, in one embodiment the underlying technology is decomposed into standardized building blocks that are linked to the business objects.

The present invention successfully bridges the gaps between business needs, operations, and underlying technology. Using the present invention, changes in business needs, services, and the supporting business processes can be reliably and easily traced down to the affected implementation elements. Likewise, changes made to the implementation elements can be reliably traced back up to the affected business processes and services. This traceability greatly enhances the ability to effectively perform change management, as well as to perform quick and accurate impact assessments. Thus the present invention provides unambiguous requirements and design leading to predictable outcomes.

Extensive reusability allows flexible, easy to deploy solutions. Definition of solutions in this manner enables disaggregation of services into building blocks and all of the advantages incumbent therein.

The present invention provides a plurality of benefits associated with standardization of components. These benefits apply both to business process as well as the underlying technology. These benefits include consistency, predictability, quality, efficiency, time to market/speed to deploy (through ease of assembly), and ease of manageability, supportability and governance.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows a block diagram of a lifecycle for establishing a baseline for existing assets.

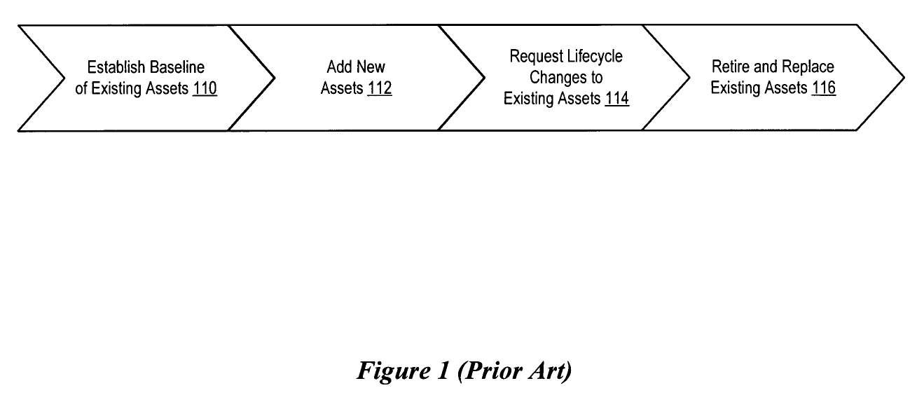

FIG. 2 shows a block diagram of a lifecycle which includes data updates to an asset lifecycle.

FIG. 3 shows a block diagram of an asset lifecycle which includes examples of service types.

FIG. 4 shows a block diagram of an asset lifecycle with examples of services within each phase of the lifecycle.

FIG. 5 shows a block diagram of standardized reusable objects configured to provide an install new asset process function.

FIG. 6 shows examples standardized, reusable of information objects as applied for an install new asset function.

FIG. 7 shows a block diagram of standardized reusable objects configured to provide a procure new asset function.

FIG. 8 shows examples of standardized reusable information objects as applied for a procure new asset function.

FIG. 9 shows a block diagram of standardized reusable objects configured to provide a repair existing asset function.

FIG. 10 shows examples of standardized reusable information objects as applied for a repair existing asset function.

FIG. 11 shows block diagrams of shared application modules and data stores that automate the execution of the various objects.

### DETAILED DESCRIPTION

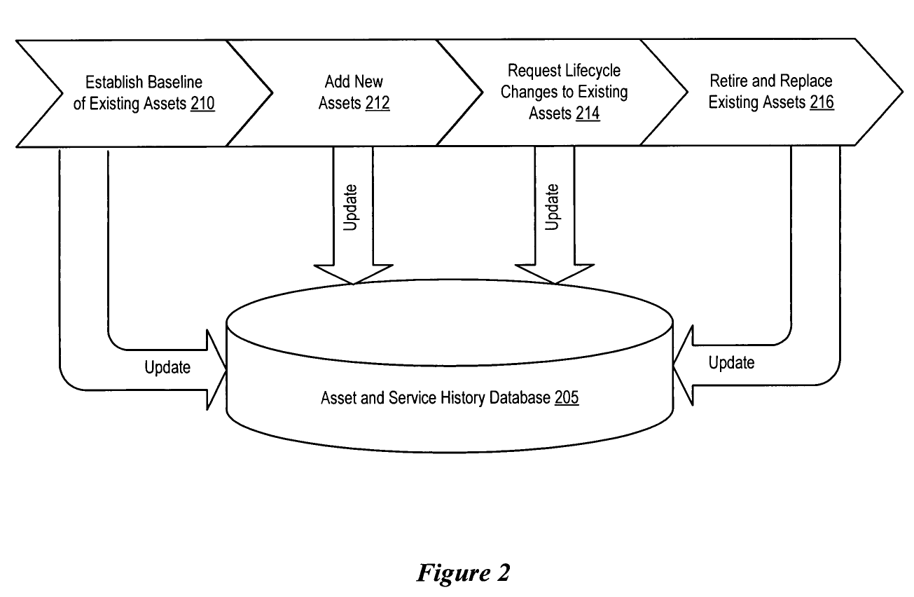

Referring to FIG. 2, each of the components of the system for unifying business objectives interact with an asset and service history database 205. More specifically, when lifecycle components establish a baseline of existing assets at step 210, the database 205 is updated. When lifecycle services add new assets, acquire new assets, order a product and install new assets or order a service at step 212, the database 205 is updated. When lifecycle components request lifecycle changes to existing assets by moving or upgrading existing assets, order a service and maintaining existing assets, or report a problem at step 214, the database 205 is updated. When lifecycle service components retire and replace existing assets by disposing of old assets, order a service and install new assets, or order a service at step 216, the database 205 is updated.

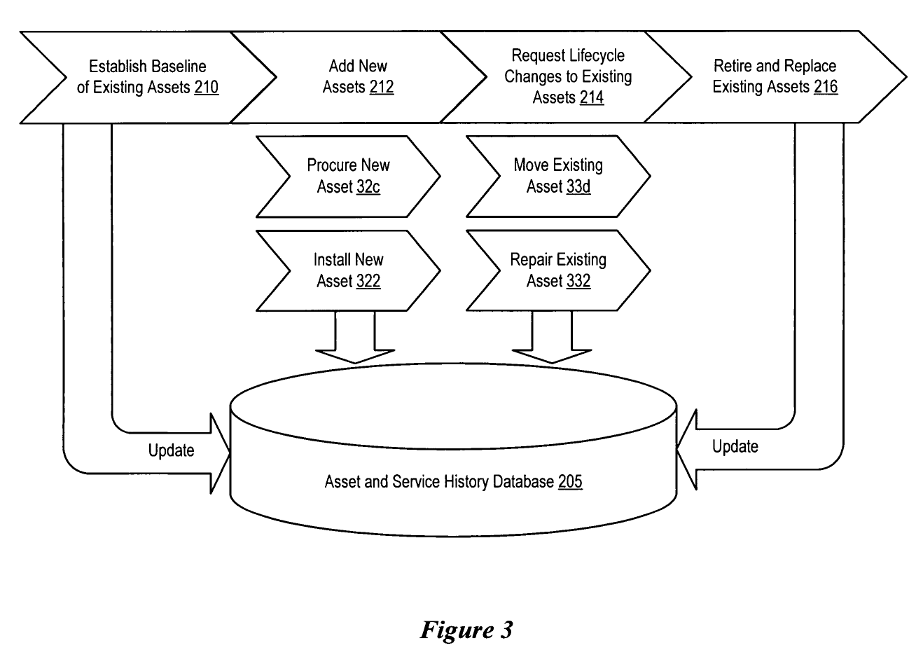

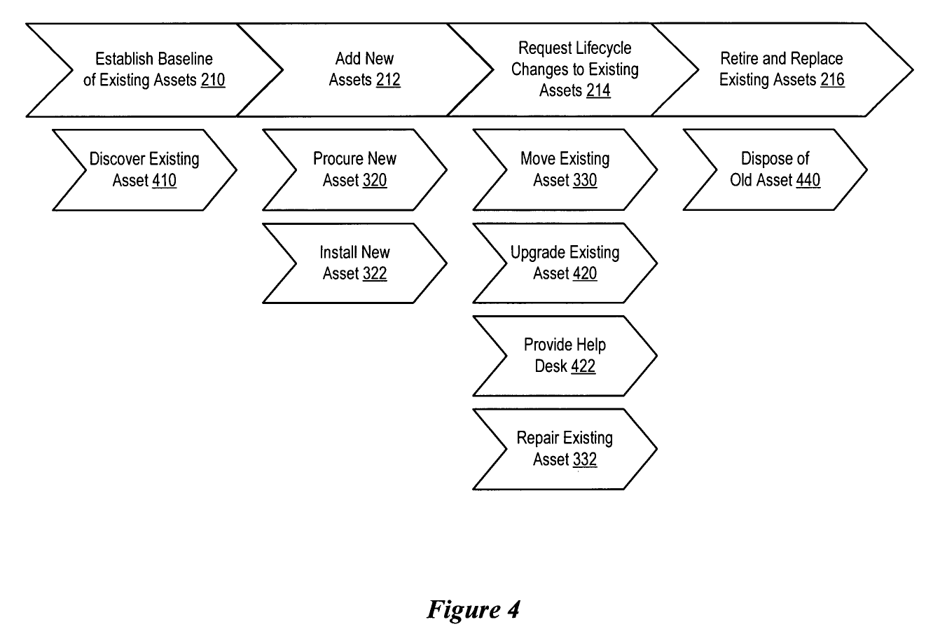

Referring to FIGS. 3 and 4, each phase of the system for unifying business objectives may include a plurality of phases, where each of the phases update the asset and service history database 205. For example, the add new assets phase 212 may include a procure new asset function 320 and an install new asset function 322. the request lifecycle changes to an existing asset phase 214 may include a move existing asset function 330 and a repair existing asset 332.

Also for example, the establish baseline of existing assets phase 210 may include a discover an existing asset function 410. The request lifecycle changes to existing assets phase 214 may further include a provide help desk function 420 or an upgrade existing asset function 422. The retire and replace existing assets phase 216 may include a dispose of old asset function 440.

Each of the phases within the system for unifying business objectives may be divided into common process objects as well as special purpose process objects. Distinct services (e.g., a procure a product service, an order a service service, and a report a problem service) each include: common information objects or constructs (request, requester, requested objects) and attributes; process steps, task, actions, both common and special purpose, that can be performed either manually or in an automated manner where common actions include: receive the request, analyze the request (decompose, apply business rules, transform into prescribed actions), schedule/initiate processing of the request, oversight of the request, update records, reporting on the results of the request, and bill for the execution of the request. Special purpose actions correspond to standard tasks that are performed solely for the purpose of fulfilling a particular type of request, e.g., the steps required for building an information handling system in the factory versus installing the product at the customer's site. Other distinct services are business rules that govern their assembly and individual behavior and common or special purpose actors, e.g., the personnel who are integral to delivering the services, and their attributes.

The services are mapped to corresponding data structures and application objects in an information technology infrastructure, work instructions in the business processes, and actors integral to the solution.

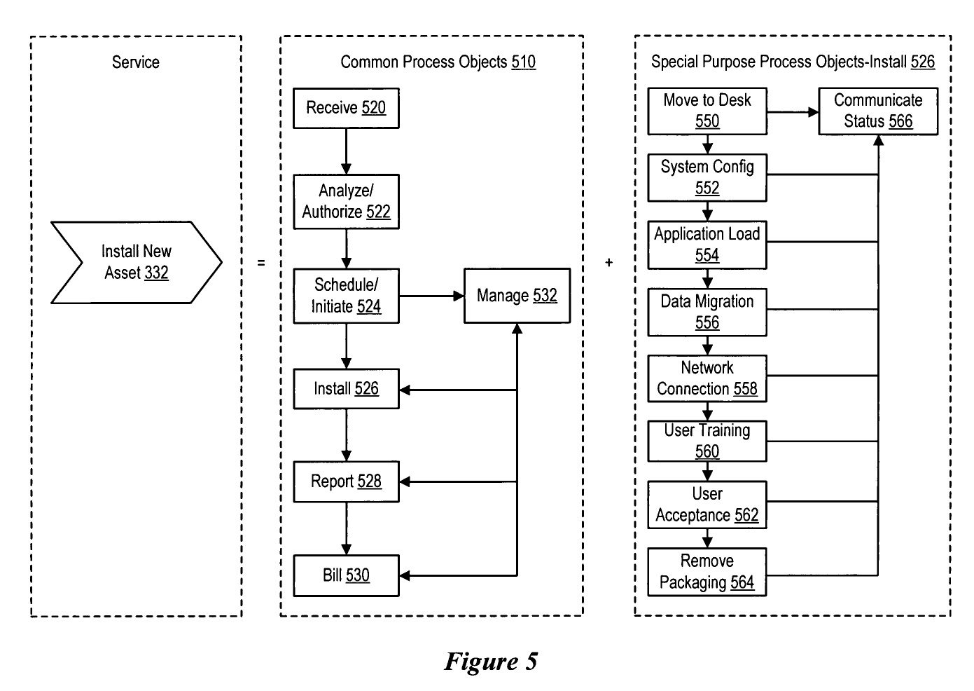

More specifically, referring to FIG. 5, an example of an install a new asset service 332 is shown. Thus, the install a new asset service 332 includes common process objects 510 as well as special purpose process objects 512 for the install new asset service 332.

The common process objects 510 include a receive object 520, an analyze/authorize object 522, a schedule/initiate object 524, an install object 526, a report object 528, a bill object 530 and a manage object 532. The receive object 520 receives and logs a request. The analyze/authorize object 522 analyzes and authorizes the request. The schedule/initiate object 524 schedules and initiates processing of a request. The install object 526 installs the request. The report object 528 reports on the request. The bill object 530 bills the request. The manage object 532 manages and oversees the request.

The special purpose process objects for the install a new asset service 332 include a move to desk object 550, a system configuration object 552, an application load object 554, a data migration object 556, a network connection object 558, a user training object 560, a user acceptance object 562, a remove packaging object 564 and a communicate status object 566. The move to desk object 550 controls physically moving a computer system from a receiving area (such as a loading dock) to an end user location. The system configuration object 552 controls connecting any peripherals and performs any set up of the operating system on the new asset. The application load object 554 controls loading applications onto the new asset. The data migration object 556 controls transfer of any end user existing data from an old end user system onto the new asset. The network connection object 558 controls connecting the new asset into the network of the end user. The user training object 560 controls training the user on how to use the new asset. The user acceptance object 562 control obtaining confirmation from the user that the service has been satisfactorily completed. The remove packaging object 564 controls physically removing any packaging materials that were used for the new asset. The communicate status object 566 communicates that status of each of the other functions.

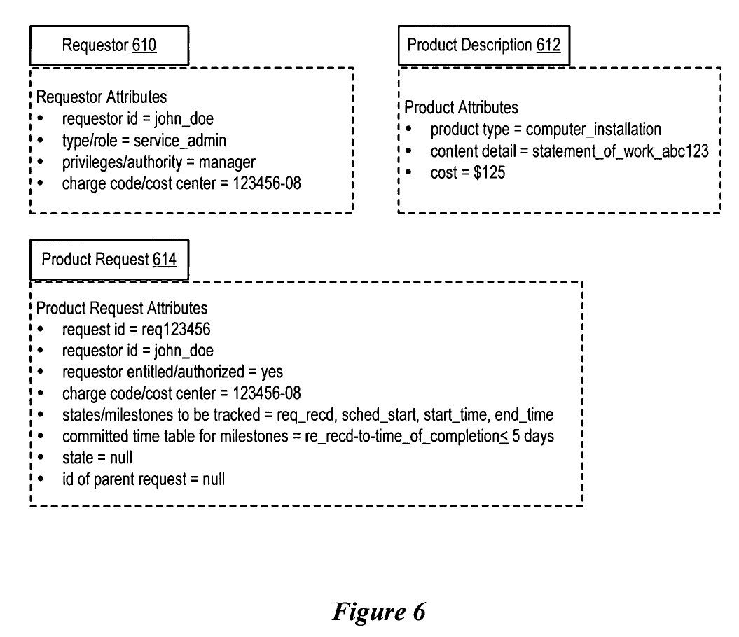

Referring to FIG. 6, examples of information objects for an install new asset function are shown. More specifically, the information objects for an install new asset function include a requester object 610, a product description object 612 and a product request object 614.

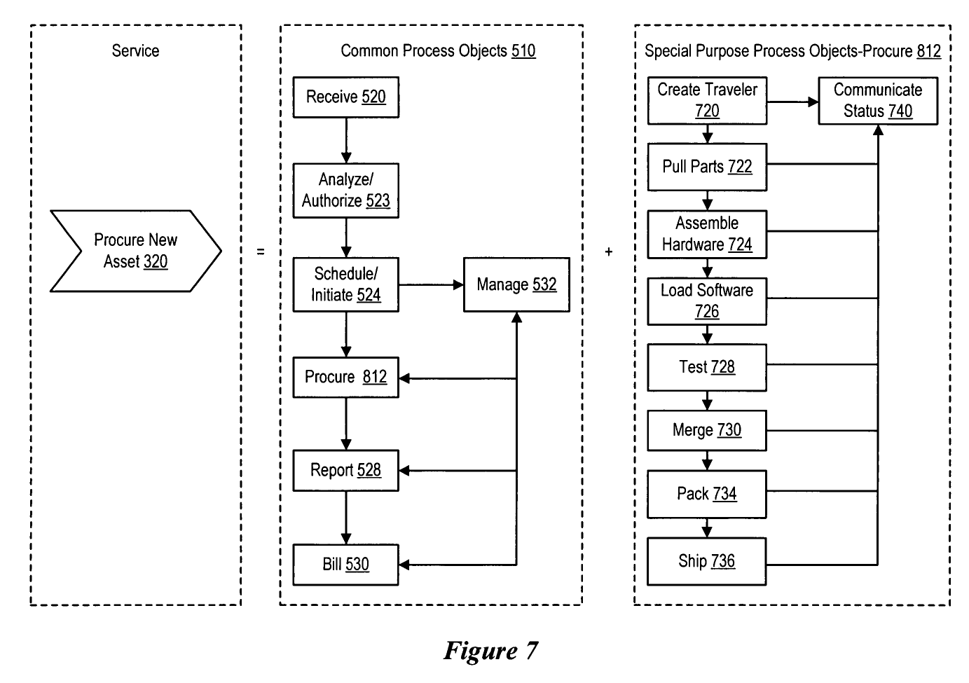

Referring to FIG. 7, a block diagram of a procure new asset function is shown. The procure new asset service 320 includes common process objects 510 as well as special purpose process objects 712 for the procure new asset service 320.

As with the install a new asset service 332, the common process objects 510 of the procure new asset services 320 includes a receive object 520, an analyze/authorize object 522, a schedule/initiate object 524, a report object 528, a bill object 530 and a manage object 532. The install a new asset service 332 also includes a special purpose procure object 712.

The special purpose process procure object 713 for the procure a new asset service 320 includes a create traveler object 720, a pull parts object 722, an assemble hardware object 724, a load software object 726, a test object 728, a merge object 730, a pack object 734, a ship object 736 and a communicate status object 740. The create traveler object 720 controls creating a detailed list of parts for a new asset. The pull parts object 722 controls pulling individual parts from their respective storage bins based upon the traveler. The assemble hardware object 724 controls assembling the parts to create the new asset. The load software object 726 controls loading software onto the newly assembled system. The test object 728 control testing the asset hardware and software. The merge object 730 controls bringing together any related products that should be shipped with the new system (e.g., a monitor). The pack object 734 controls packing the new system and related products for shipping. The ship object 736 controls shipping the asset and related products from the factory for delivery to the customer. The communicate status object 740 communicates the status of each of the other functions.

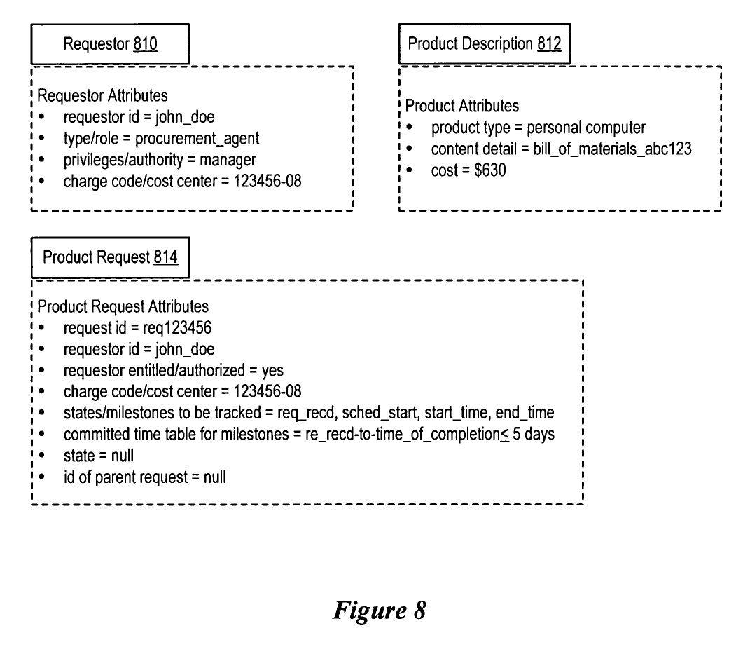

Referring to FIG. 8, examples of information objects for a procure new asset function are shown. More specifically, the procure new asset function includes a requester object 910, a product description object 812 and a product request object 814.

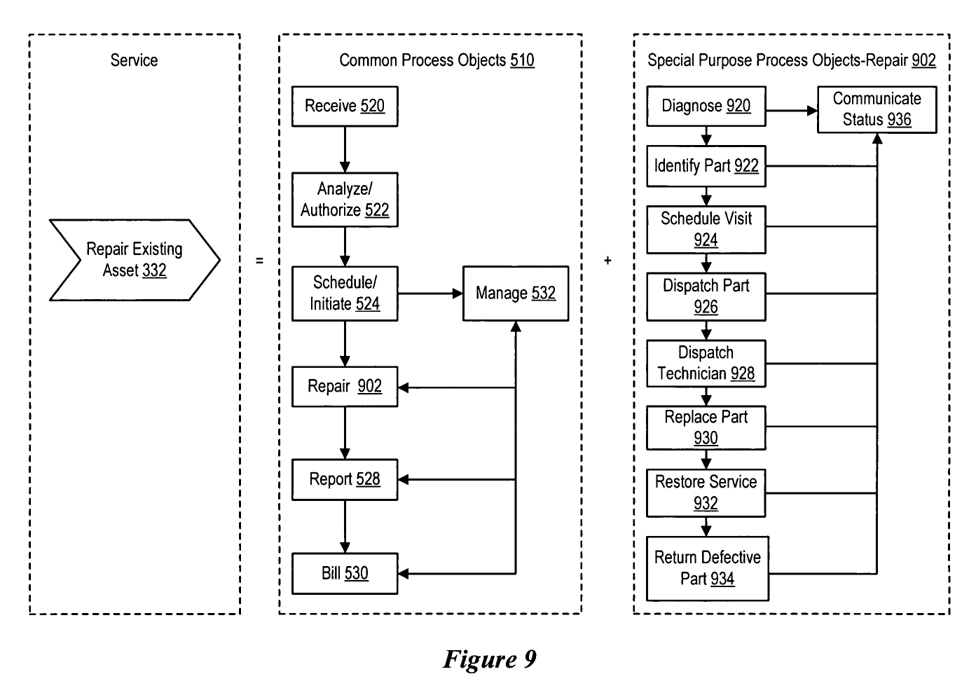

Referring to FIG. 9, a block diagram of a repair existing asset function 332 is shown. The repair existing asset function 332 includes common process objects 510 as well as special purpose process objects 912 for the repair existing asset function 332.

As with the install a new asset service 332 and the procure new asset service 320, the common process objects of the repair existing asset function 332 includes a receive object 520, an analyze/authorize object 522, a schedule/initiate object 524, a report object 528, a bill object 530 and a manage object 532. The install a new asset service 332 also includes a special purpose repair object 912.

The special purpose process repair object 912 includes a diagnose object 920, an identify part object 922, a schedule visit object 924, a dispatch part object 926, a dispatch technician object 928, a replace part object 930, a restore service object 932, a return defective part 934 and a communicate status object 936. The diagnose object 920 controls diagnosing the customer's problem. The identify part object 922 control identifying the part or parts required to repair the identified problem. The schedule visit object 924 control scheduling the visit of a service technician to fix the problem. The dispatch part object 926 control sending the replacement part to the service technician. The dispatch technician object 928 controls sending the service technician to the customer site. The replace part object 930 controls the service technician replacing the defective part with the replacement part. The restore service object 932 controls the service technician restoring the customer system to working order. The return defective part 934 controls the service technician returning the defective part. The communicate status object 936 communicates that status of each of the other functions.

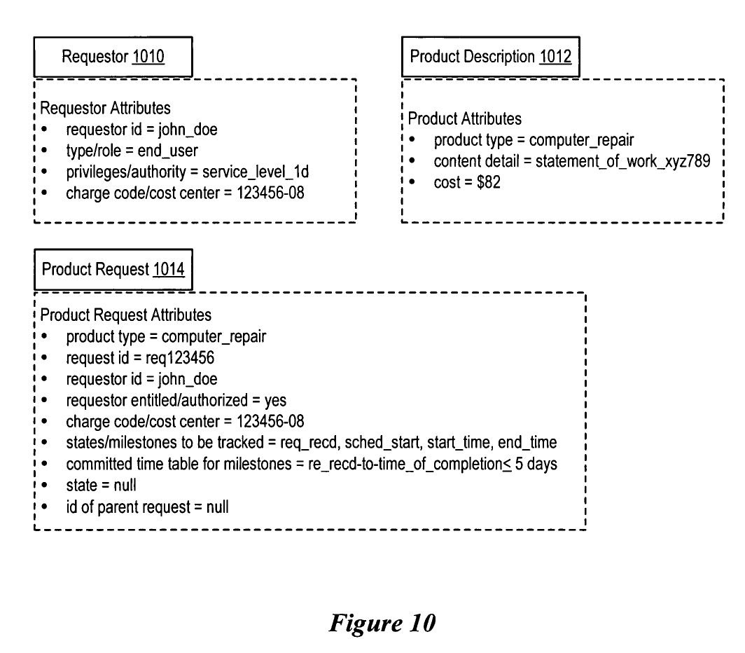

Referring to FIG. 10, examples of information objects for a repair existing asset function are shown. More specifically, the repair an existing service function 332 includes a requester object 1010, a product description object 1012 and a product request object 1014.

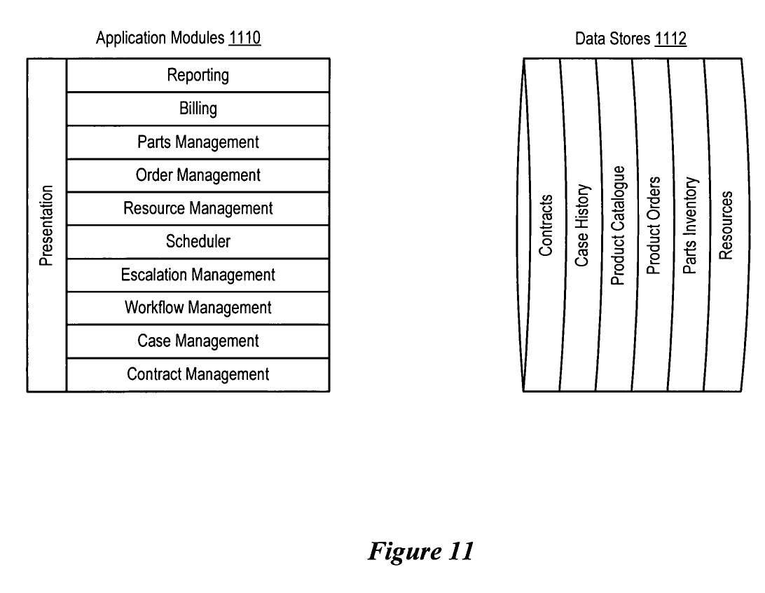

Referring to FIG. 11, block diagrams of the application modules and data stores are shown. Because of the system for unifying business objects, the application modules and data stores transcend each of the functions (i.e., the application modules 1110 and data stores 1112 apply for each of the specific functions within the system.) More specifically, the install a new asset function interacts with application modules 1110 and data stores 1112. The procure a new asset function interact with the application modules 1110 and data stores 1112. The repair existing asset function interact with the application modules 1110 and data stores 1112. The application modules 1110 and the data stores 1112 are generalized due to the system for unifying business objectives.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for configuring service solutions comprising:
defining and building service solutions based upon building block services, a building block service being any discrete benefit explicitly provided by a vendor to a customer of the vendor, the building block service including at least one of a physical product, a service and a solution.

2. The method for claim 1 wherein:
the physical product includes an information handling system, the service includes installation or repair of the physical product, and the solution includes a combination of properly configured information technology systems, clearly defined business processes, and trained personnel.

3. The method for claim 1 wherein:
the building block services can be defined according to a standard construct of irreducible objects or primitives.

4. The method of claim 3 wherein:
the standard constructs are based upon or include a common generalized object and repeatable special purpose objects that can be combined according to pre-defined business rules or objects that can be created in a standardized manner.

5. The method of claim 4 wherein:
the various objects correspond directly to either existing physical elements or building blocks that comprise the information technology infrastructure that is used to enable the solution or result in definition and creation of new infrastructure elements, or correspond to either existing or new process objects comprised of standard work instructions for people, or any combination existing physical elements, new infrastructure elements.

6. The method of claim 5 wherein:
the information technology infrastructure includes applications, data structures, presentation logic.

7. The method of claim 6 wherein:
specification and configuration of the building block services and the specification and configuration of the underlying objects or primitives within the building block services, translates directly into an operation information technology (IT) and process solution.

8. The method of claim 7 wherein:
changes made to the service solution result in and are traceable to the appropriate and necessary changes in an IT infrastructure and business processes; likewise, changes made to the IT infrastructure can be clearly traced to the affected solutions and services.

9. The method of claim 8 wherein:
changes made to the IT infrastructure can be clearly traced to the affected solutions and services.

10. An apparatus for configuring service solutions comprising:
means for defining and building service solutions based upon building block services, a building block service being any discrete benefit explicitly provided by a vendor to a customer of the vendor, the building block service including at least one of a physical product, a service and a solution.

11. The apparatus for claim 10 wherein:
the physical product includes an information handling system, the service includes installation or repair of the physical product, and the solution includes a combination of properly configured information technology systems, clearly defined business processes, and trained personnel.

12. The apparatus for claim 10 wherein:
the building block services can be defined according to a standard construct of irreducible objects or primitives.

13. The apparatus of claim 12 wherein:
the standard constructs are based upon or include a common generalized object and repeatable special purpose objects that can be combined according to pre-defined business rules or objects that can be created in a standardized manner.

14. The apparatus of claim 13 wherein:
the various objects correspond directly to either existing physical elements or building blocks that comprise the information technology infrastructure that is used to enable the solution or result in definition and creation of new infrastructure elements, or correspond to either existing or new process objects comprised of standard work instructions for people, or any combination existing physical elements, new infrastructure elements.

15. The apparatus of claim 14 wherein:
the information technology infrastructure includes applications, data structures, presentation logic.

16. The apparatus of claim 14 wherein:
specification and configuration of the building block services and the specification and configuration of the underlying objects or primitives within the building block services, translates directly into an operation information technology (IT) and process solution.

17. The apparatus of claim 16 wherein:
changes made to the service solution result in and are traceable to the appropriate and necessary changes in an IT infrastructure and business processes; likewise, changes made to the IT infrastructure can be clearly traced to the affected solutions and services.

18. The apparatus of claim 17 wherein:
changes made to the IT infrastructure can be clearly traced to the affected solutions and services.
